(19) United States
(12) Patent Application Publication
(10) Pub. No.: US 2011/0289229 A1
(43) Pub. Date: Nov. 24, 2011

(54) METHODS AND SYSTEMS FOR WI-FI SETUP AND CONFIGURATION

(75) Inventor: Ramanathan Subramaniam, Old Bridge, NJ (US)

(73) Assignee: BridgeCo Inc.

(21) Appl. No.: 13/098,779

(22) Filed: May 2, 2011

Related U.S. Application Data
(60) Provisional application No. 61/331,459, filed on May 5, 2010.

(51) Int. Cl. G06F 15/16; H04W 76/02

(52) U.S. Cl. 709/228

(57) ABSTRACT

The present invention relates generally to the configuration of wireless networks and the configuration of electronic devices to connect to wireless networks, especially when those electronic devices have limited user interfaces and/or no display screen. The present invention makes use of devices already connected to a wireless network, previously connected to a wireless network, or capable of acting as an interface to discover the connection settings required to connect to the wireless network. The present invention further uses a shared communication medium between that connected device and an unconnected device in order to share the connection settings needed to connect the unconnected device.

### CROSS-REFERENCE TO RELATED APPLICATIONS

This application claims priority to and the benefit of U.S. provisional patent application with Ser. No. 61/331,459 filed on May 5, 2010, entitled “WiFi Setup Configuration.”

### FIELD OF THE INVENTION

The present invention relates generally to the configuration of wireless networks and the configuration of electronic devices to connect to wireless networks, especially when those electronic devices have limited user interfaces and/or no display screen.

### BACKGROUND

Establishing a basic at-home wireless network between traditional computing devices (e.g., desktop and laptop computers) has become very easy. For example, next-generation customer-premises equipment for broadband access (e.g., cable and DSL modems provided by Internet service providers) may directly support wireless networks. Alternatively, a user may connect a wireless access point (“WAP”) to a broadband modem to create a wireless home network.

A simple, unsecured wireless network, however, may permit anyone to snoop on the conversations between the devices and/or gain access to the network and the information being exchanged. To avoid these unwanted intrusions, access points may be configured to use wireless security. A secure wireless network is created by sharing confidential information among the various devices and the WAP. The WAP may then be used for the establishment of a wireless connection.

Over the years, various wireless security schemes have evolved, such as Wired Equivalent Privacy (“WEP”), Wi-Fi Protected Access (“WPA”), and WPA2. These schemes often involve complex, hexadecimal “keys” or passwords as a part of the confidential information that is shared among the devices. The process of securing a wireless network involves configuring the router for the desired type of security and then providing each wireless client with the settings and passwords to be used (i.e., the ones associated with the type of security scheme used in the router). This process may be tedious and challenging for an average home user, especially when the device requiring wireless configuration settings has limited input and display capabilities, such as a digital media player. As demand for networked and internet-based media rises, however, more next-generation media-rendering devices support networking—preferably wireless networking, given its ease and convenience of use.

To address the above-mentioned problem, some efforts have been made to simplify wireless network security. For example, the Wi-Fi Alliance promotes a set of standards known as Wi-Fi Protected Setup (“WPS”) for the purpose of simplifying wireless configuration. Additionally, newer versions of Microsoft Windows support a technology called Windows Connect Now (“WCN”) that supports storing configuration settings on a portable storage device, such as a USB flash memory, and transferring the settings to a device that needs to be configured. However, this does not completely solve the problems explained above, as most access points currently deployed still do not support WPS. Therefore, WPS is rarely an adequate solution. Further, the devices that need to be configured may not support interfaces for portable/removable storage media as required by WCN. Therefore, WCN is rarely an adequate solution.

There is, therefore, a remaining need in the field to be able to setup devices to connect to a wireless network with ease, especially when those devices have limited user interfaces.

### SUMMARY OF THE INVENTION

Accordingly, techniques and supporting systems and methods as described herein address the above-described problems, as well as other issues facing users of wireless networks. In order for users to fully realize the benefits of wireless networks and the benefits of a growing number of wireless-enabled devices, it must become simpler to configure devices to connect to wireless networks, regardless of the type of device and user interface present on the device.

Therefore, in one aspect of the present invention, a system facilitates the addition of an electronic device to a wireless network. The system includes a module for triggering the electronic device to enter a configuration mode and a settings module for gathering settings pertaining to connecting a device to the wireless network. The settings are gathered from a computing device that may already be a member of the wireless network, however, it is also possible that the computing device is not a member of the wireless network. For instance, it is possible that the computing device was at one point a member of the wireless network but is no longer a member, or else that the computing device simply has the wireless network settings without having ever been a member of the wireless network. It is also possible that the computing device acts as an interface to retrieve the wireless settings without wireless capabilities. In this case, it is possible that the computing device is not even capable of being a member of the wireless network.

The system also includes a module for connecting the computing device to the electronic device using a network link. The system also includes a module for configuring the electronic device to connect to the wireless network using the gathered settings and the network link.

In certain embodiments, the system includes a wireless network using an IEEE 802.11 protocol for communication, and, in some cases the wireless network is secured using WEP, WPA, or WPA2. The computing device may include a display screen, whereas in some implementations the electronic device is devoid of a display screen. In some embodiments, the triggering module is triggered based on input from a user interacting with the electronic device.

In further embodiments, while in configuration mode the electronic device transmits requests for ad hoc networks to all computing devices within transmission range, and, in some cases, establishes itself as a wireless access point and transmits its presence as well as a pre-specified SSID indicating that the electronic device is in configuration mode.

In some implementations, the settings module gathers the connection settings from the computing device on which it is located, from the wireless access point, and/or from a user of the computing device.

In another aspect of the present invention, a computer-implemented method facilitates the addition of an electronic device to a wireless network. The method includes triggering the electronic device to enter a configuration mode and gathering settings pertaining to connecting a device to the wireless network from a computing device. The method also includes connecting the computing device to the electronic device using a network link and configuring the electronic device to connect to the wireless network using the settings and the network link.

In certain embodiments, the wireless network uses an IEEE 802.11 protocol for communication, and in some cases the network may also be secured using WEP, WPA, or WPA2.

The trigger to enter configuration mode may, in some cases, be based on input from a user interacting with the electronic device. While in configuration mode, the electronic device may transmit requests for ad hoc networks to all computing devices within transmission range. In certain implementations, the electronic device establishes itself as a wireless access point and transmits its presence as well as a pre-specified SSID indicating that the electronic device is in configuration mode.

The connection settings may be gathered from a computing device other than the wireless access point that created the wireless network, from the wireless access point that created the wireless network, and/or from a user via an input device on/with the computing device.

It is to be understood that both the foregoing general description of the invention and the following detailed descriptions are exemplary, but are not restrictive, of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 illustrates an exemplary network diagram of various devices that are members of a wireless network and one electronic device that is not a member of the wireless network according to various embodiments of the invention;

FIG. 2 illustrates an exemplary block diagram of a computing device that is a member of a wireless network and an electronic device that is not a member of the wireless network according to various embodiments of the invention;

FIG. 3 illustrates an exemplary block diagram of a computing device, containing various modules, that is a member of a wireless network and an electronic device, containing one module, that is not a member of the wireless network according to various embodiments of the invention, and the two devices are connected by a network link; and

FIG. 4 illustrates an exemplary flow diagram for joining an electronic device to a wireless network according to various embodiments of the invention.

### DETAILED DESCRIPTION

The detailed description set forth below, in connection with the associated drawings, is intended to provide a description of the presently-preferred embodiments of the invention, and is in no way intended to limit the forms in which the present invention may be construed or used. Accordingly, it is well-understood by those with ordinary skill in the art that the same or equivalent functions may be accomplished by different embodiments that are also intended to be encompassed within the spirit and scope of the present invention. Moreover, with respect to particular method steps, it is readily understood by those with skill in the art that the steps may be performed in any order, and are not limited to any particular order unless expressly stated or otherwise inherent within the steps.

The systems and methods described herein facilitate the joining of an electronic device to a wireless network using a computing device that is already a member of the wireless network. The term “wireless network” is used herein to describe a set of networked devices that exchange data through a device that functions as a wireless access point. While a wireless network may have devices as members of the network that are not connected wirelessly, but rather through physical wire, a wireless network when used herein indicates that at least one member of the network is a wireless access point, thereby enabling devices to join using wireless connectivity should such a wireless-enabled device be present. When used herein, the terms “join” and “connect” and “member of” in relation to a wireless network indicate that a device is capable of communicating with at least the wireless access point of the wireless network. As noted above, a device that is a member of, connects to, or joins a wireless network need not actually effectuate communication with the wireless access point using wireless communication. However, all three of these terms when used herein indicate that such a device is sufficiently configured to comply with any security settings that the wireless access point may be enforcing. The terms “computing device” and “electronic device” are used very generally herein and describe any device with an electronic circuit and capable of executing instructions. The terms “computing device” and “electronic device” will typically be used in contradistinction to denote respectively a device presently a member of the wireless network and a device not presently a member of the wireless network. Notably while a computing device may be a member of the wireless network using a wireless and/or wired connection, and while the electronic device may be capable of a wired connection in addition to a wireless connection, an “electronic device” as used herein must be capable at least of a wireless connection, as the object of the invention is generally to connect the electronic device to the wireless network.

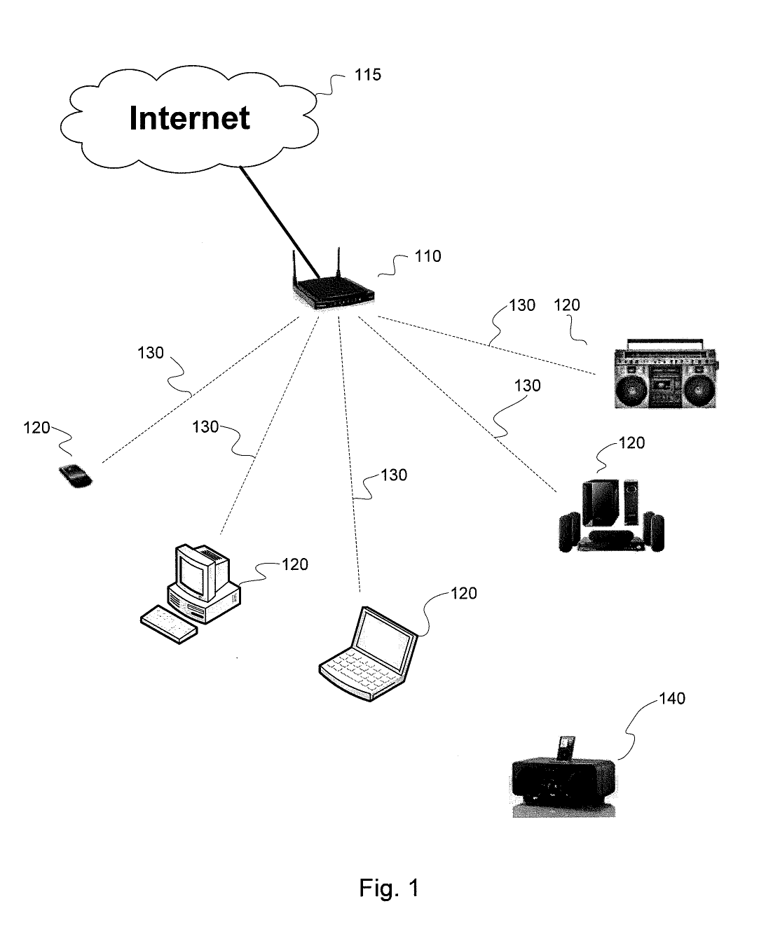

As shown in FIG. 1, a wireless access point 110 creates a wireless network of which computing devices 120 are members. As illustrated, a computing device can be any sort of device. For example, it may be a cellular phone, a desktop computer, a laptop computer, tablet computer, a receiver and speaker system, television, as well as a stereo system as shown in FIG. 1. There are, however, many other forms of devices that would constitute computing devices for the purposes of this invention. The invention is indifferent to the type of computing device. The computing devices are members of the wireless network because they are connected to the wireless access point 110 via network links 130.

In one embodiment of the invention, network link 130 is a wireless connection using a wireless communication protocol shared between the computing device 120 and the wireless access point 110. Given the popularity of wireless-enabled devices, this embodiment is common in practice. A typical wireless communication protocol is the family of IEEE 802.11 protocols. For example, a laptop computer may communicate with a wireless access point using IEEE 802.11n. In this scenario, therefore, the computing device 120 is a laptop and the network link 130 is the wireless connection using a IEEE 802.11n protocol between the laptop and the wireless access point 110.

In another embodiment of the invention, such a network link 130 includes a wired connection using a “wired” communication protocol shared between the computing device 120 and the wireless access point 110. A person with ordinary skill in the art would understand that a conventional wired network may comprise a desktop computer communicating with a wireless access point via a Cat 5 cable and the Ethernet protocol. In this scenario, therefore, the computing device 120 is a desktop computer and the network link 130 is the wired connection using Ethernet over a Cat 5 cable connecting the desktop computer and the wireless access point.

As shown in FIG. 1, the wireless access point 110 may be connected to the Internet 115. It may also be connected to some other external network. While such situations are highly foreseeable, the invention would still cover a situation where the wireless access point 110 is not connected to the Internet 115 or an external network. If the wireless access point 110 is connected to an external network, the modem used for interfacing with that external network may be integrated into a single device with the wireless access point. It is also foreseeable, though, that the modem may be external to the device that contains the wireless access point, which would therefore necessitate some sort of network link between the wireless access point 110 and the external modem.

As shown in FIG. 1, the computing devices 120 are connected to the wireless access point 110 via a network link 130. However, this diagram is simplified and not intended to imply that the computing devices 120 must connect with the wireless access point 110 via a point-to-point network link 130. It is known to persons with ordinary skill in the art that different communication protocols implement different communication methods. In particular, some communication protocols implement point-to-point communications while others implement broadcast communications. Wireless communications typically implement broadcast communications. Therefore, it is foreseen that the present invention can be implemented for wireless networks where the computing devices 120 communicate in a variety of methods, including in point-to-point fashion and broadcast fashion. Therefore, while FIG. 1 demonstrates network links 130 running directly from wireless access point 110 to each computing device 120, the present invention as well as this diagram are intended to also describe implementations in which the computing devices 120 are broadcasting their communications with the wireless access point 110 and thus are effectively transmitting to other computing devices 120, even though no such network links are shown.

As shown in FIG. 1, an electronic device 140 is not a member of the wireless network because it is not communicating with the wireless access point 110. For the purposes of this invention, the wireless device 140 is capable of a wireless connection to wireless access point 110. However, the electronic device 140 is not a member of the wireless network because it is not configured with the appropriate security settings that are being enforced by the wireless access point 110 against devices connected using a wireless connection.

Such security settings may come in a variety of forms. Persons with ordinary skill in the art would realize that security settings are often implemented through an industry standard protocol, such as WEP, WPA, or WPA2. Regardless of the particular security settings being used, FIG. 1 depicts a situation where an electronic device 140 is otherwise capable of forming a wireless connection to a wireless access point 110, but for certain pieces of information that the wireless access point 110 requires the electronic device 140 to provide in order to allow the electronic device 140 to join the network.

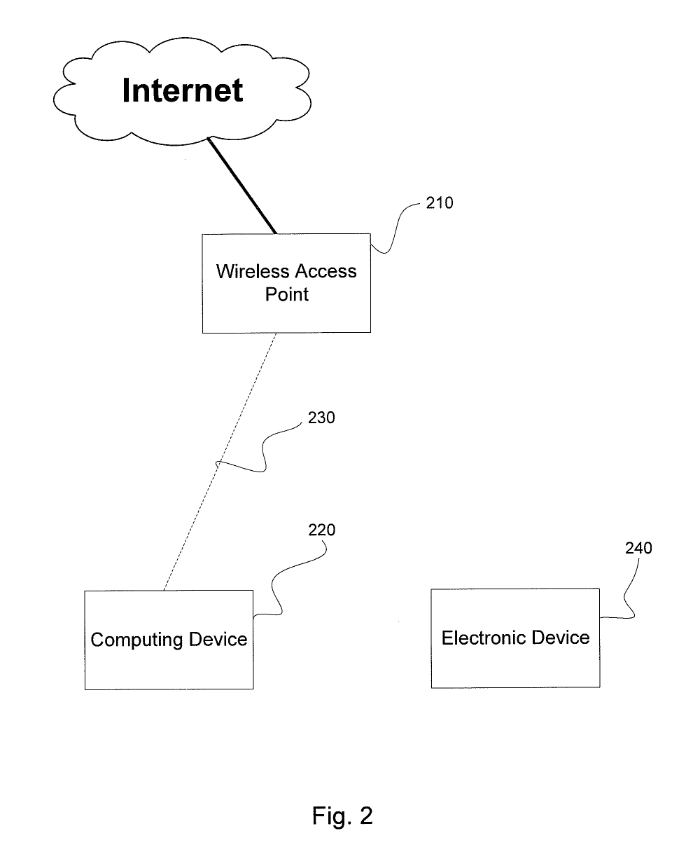

As shown in FIG. 2, a wireless access point 210 creates a wireless network having computing device 220 as a member. The computing device 220 is a member of the wireless network because it is connected to the wireless access point 210 via network link 230. Similar to the network link in FIG. 1, the network link 230 in FIG. 2 can take numerous forms, including wired and wireless forms of connections. Further, there is an electronic device 240 that is not a member of the wireless network because it is not communicating with the wireless access point 210. As in FIG. 1, the wireless device 240 is capable of a wireless connection to wireless access point 210. However, the electronic device 240 is not a member of the wireless network because it is not configured with the appropriate security settings that are being enforced by the wireless access point 210 against devices connected using a wireless connection.

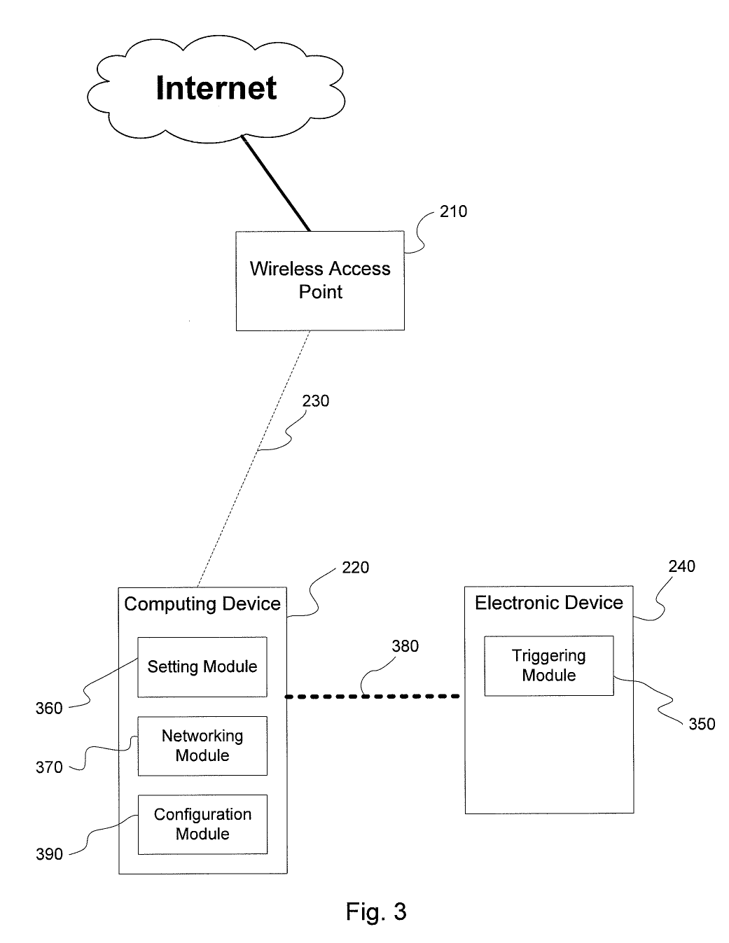

As shown in FIG. 3, a wireless access point 210 creates a wireless network of which a computing device 220 is a member. The computing device 220 is a member of the wireless network because it is connected to the wireless access point 210 via network link 230. Similar to FIG. 1 and FIG. 2, the network link 230 in FIG. 3 can take numerous forms, including wired and wireless forms of connections. Further, electronic device 240 is not a member of the wireless network because it is not communicating with the wireless access point 210. As in FIG. 1 and FIG. 2, the wireless device 240 in FIG. 3 is capable of a wireless connection to wireless access point 210. However, the electronic device 240 is not a member of the wireless network because it is not configured with the appropriate security settings that are being enforced by the wireless access point 210 against devices connected using a wireless connection.

Also in FIG. 3 there is a triggering module 350 located on the electronic device 240. This triggering module 350 takes some form of input and puts the electronic device 240 into configuration mode should certain conditions of that input be met.

The input received by the triggering module 350 can take a variety of forms. In one embodiment, the electronic device 240 has a physical button on its outer case that a user is able to depress. When the button is depressed, the triggering module 350 places the electronic device 240 into configuration mode. In another embodiment, the electronic device has a touch screen input on which a virtual button is displayed. When the button is selected, the triggering module 350 puts the electronic device 240 into configuration mode. In another embodiment of the invention, the triggering module 350 receives as input the set of wireless networks, as identified by their corresponding SSIDs, detected by the electronic device 240. Upon detection of some pre-specified SSID, the triggering module 350 places the electronic device 240 into configuration mode. In other implementations, the triggering module 350 receives timing information, such as clock cycles or time of day. In such cases the triggering module 350 places the electronic device 240 into configuration mode at certain times of the day or at certain intervals (e.g., every five minutes). These triggering mechanisms are merely examples of certain possible triggering devices that may be used and are not meant to limit the scope of inputs that the triggering module 350 can receive.

Based on receiving the proper input, the triggering module 350 places the electronic device into configuration mode which allows the electronic device 240 to interact with the computing device 220 as described below. Regardless of what form the interaction with the computing device 220 takes, the configuration mode permits such interactions to take place.

In one embodiment, when placed into configuration mode, the electronic device 240 transmits requests to form ad hoc wireless networks to computing devices within the range of its transmission. Such a computing device 220 can detect the ad hoc network requests and form a network link with the electronic device 240 as described below. In another instance when the triggering module 350 puts the electronic device 240 into configuration mode, the electronic device 240 configures itself as a wireless access point with a pre-specified SSID and transmits its presence. In such a case, computing device 220, which is in range of electronic device 240 transmissions, detects the pre-specified SSID and is thereby able to create a network link with the electronic device 240. In another instance when the triggering module 350 puts the electronic device 240 into configuration mode, the electronic device 240 communicates configuration requests to all devices to which it is connected. These other devices may be connected to the electronic device 240 by wireless connections or by wired connections, such as over a USB or UART/ANALOG interface. When configuring the electronic device using a docked computing device, the need to explicitly trigger the electronic device into configuration mode may be avoided. The triggering may instead be effected by the user performing some action on the docked device (e.g., launching a configuration application).

Still referring to FIG. 3, a setting module 360 is located on the computing device 220. This setting module 360 detects the computing device 220 connection to the wireless access point 210 via network link 230 and gathers settings pertaining to that connection. When wireless access point 210 is enforcing security settings on connected wireless devices, such as computing device 220 if it is connected wirelessly, the setting module gathers the security settings necessary for a device to connect to the wireless access point 210, such as a security protocol and/or a passphrase.

In certain embodiments, the setting module 360 gathers settings pertaining to the wireless access point 210 by querying the operating system or a network utility running on the computing device 220. In such a situation, the setting module 360 determines what information the computing device 220 used to connect to wireless access point 210 and stores that information for later configuration of the electronic device 240. In this embodiment, it is likely that the network link 230 between the computing device 220 and the wireless access point 210 is a wireless network connection, in which case the setting module 360 gathers wireless connection settings, as it is unlikely that the computing device 220 will have such settings if it is not itself using a wireless connection to wireless access point 210.

In another embodiment of the invention, the setting module 360 gathers settings pertaining to the wireless access point 210 by querying the wireless access point 210. This may take the form of the setting module 360 remotely querying the operating system or a network utility on the wireless access point 210 to determine which security settings are being used for wireless connections. This may also take the form of the setting module 360 communicating with a separate module running on the wireless access point 210 specifically providing such information to requesting modules such as the setting module 360. The module providing such settings may, in some cases, require that a requesting module be running on a device that is already using proper security settings and thereby a member of the wireless network. In such a case, the settings gathering module stores the connection settings provided by the wireless access point 210.

In other configurations, the setting module 360 gathers settings pertaining to the wireless access point 210 by querying a user of the computing device 220 for the information. This may take the form of creating and displaying a prompt on some user interface of the computing device 220 thereby requesting the user to enter security settings which the setting module 360 then stores for subsequent user.

In another configuration, the setting module 360 acts as an interface by gathering settings pertaining to the wireless access point 210 by querying the user of the computing device 220 for the information. In this exemplary embodiment, network link 230 may be ineffectual or not present at all. However, the setting module 360 may gather settings for wireless access point 210 from a user of the computing device, so the computing device 220 does not actually need to be a member of the wireless network. This configuration could cover situations where the computing device is in fact a member of the wireless network, situations where the computing device 220 had never been a member of the wireless network, and situations where the computing device 220 had at one time been a member of the wireless network (but e.g., no longer has accurate settings for the wireless access point 210 or simply is no longer connected to the wireless access point).

Also in FIG. 3, a networking module 370 is located on the computing device 220. This networking module 370 detects electronic device 240 when that device is in configuration mode. The networking module 370 then establishes a network link 380 between the computing device 220 and the electronic device 240.

In one embodiment of the invention, the networking module 370 detects that electronic device 240 is in configuration mode as it monitors the wireless network information received by the computing device 220 and notices a request for an ad hoc network by electronic device 240. In such a situation, networking module 370 causes computing device 220 to accept the ad hoc network request, thereby establishing a network link 380 as a wireless connection between computing device 220 and electronic device 240.

The networking module 370 may also detect when electronic device 240 is in configuration mode as it monitors the wireless networks that computing device 220 detects, and notices that a wireless network with a pre-specified SSID is detected by computing device 220 as it is transmitted by electronic device 240. In such a situation, networking module 370 may cause computing device 220 to request a connection to the wireless network created by electronic device 240. When electronic device 240 accepts the request to join the network, network link 380 has been established between the computing device 220 and electronic device 240 as a wireless network connection.

In another embodiment of the invention, the networking module 370 detects when the electronic device 240 is in configuration mode as it monitors the messages received by the computing device 220 from devices to which it is connected, and notices a configuration request communicated from the electronic device 240 to which it is already connected. In such a situation, networking module 370 may not need to create the network link 380 as the devices are already connected. This embodiment, for instance, allows for a situation where the electronic device 240 is connected to the computing device 220 via a USB interface, and the electronic device 240 communicates configuration requests to all devices to which it is connected, thereby communicating a configuration request to the computing device 220 which is detected by networking module 370.

While the above mentioned embodiments are ideal techniques of forming network link 380 between computing device 220 and electronic device 240, it is foreseen that a variety of other network links can be formed, including wired links, that fall within the scope of this invention.

Also in FIG. 3, a configuration module 390, located on the computing device 220, uses the connection settings information gathered by the settings gathering module 360 and uses network link 380 in order to configure electronic device 240 to connect to the wireless network created by wireless access point 210.

In certain cases, the configuration module 390 communicates across network link 380 with the operating system or a network utility on electronic device 240. In such a situation, configuration module 390 provides the connection settings information gathered by the module 360 to the operating system or network utility thereby causing the operating system or network utility to properly store the connection settings. The configuration module 390 then terminates network link 380 or prompts the networking module 370 to do so given that the electronic device 240 is now properly configured and able to join the wireless network created by wireless access point 210.

In another embodiment, the configuration module 390 communicates across network link 380 with a module running on the electronic device 240 that receives configuration information. In such a situation, configuration module 390 provides the connection settings information gathered by the setting module 360 to the configuration information receiving module running on electronic device 240, and that module then properly stores the connection information on the electronic device 240. The configuration information receiving module, the configuration module 390, or the networking module 370 then terminates network link 380, given that the electronic device 240 is now properly configured and able to join the wireless network created by wireless access point 210. The configuration information receiving module may be implemented in a variety of technologies, such as a web service or some other web interface or a proxy agent.

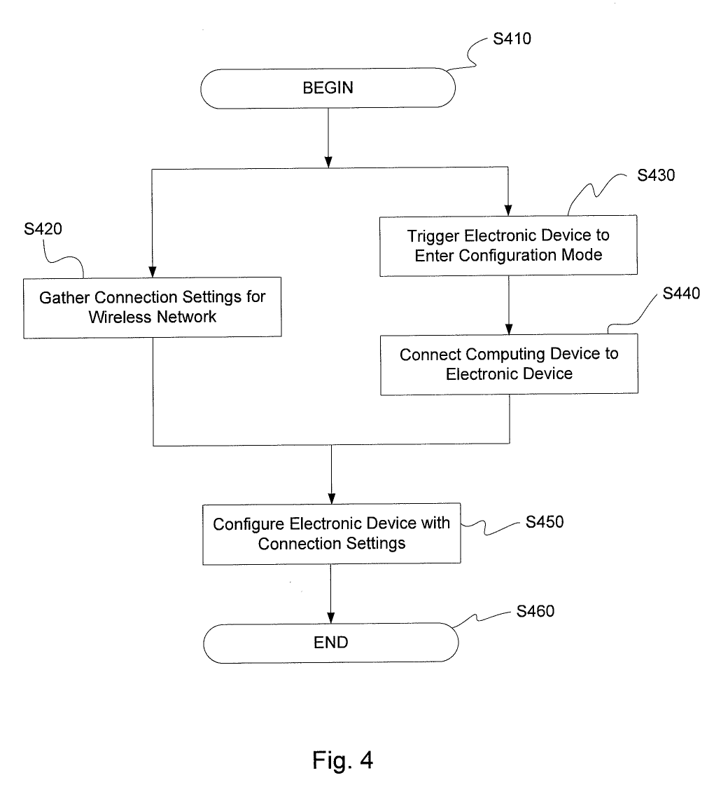

FIG. 4 illustrates a method for joining an electronic device to a wireless network using a computing device already connected to that wireless network. The process begins in step S410 at which point control passes to steps S420 and S430 in parallel. While steps S420 and S430 need not happen concurrently, neither step is dependent on the other, so either may take place before the other or they may occur concurrently.

At step S420, connection settings are gathered for the wireless network to which the electronic device is to join. While these settings may be gathered in a variety of fashions, it is foreseen that these settings will be available on the computing device already connected to the wireless network and that, therefore, the connection settings can be gathered from that computing device, namely its operating system or a network utility operating thereon. These settings can also be obtained from the wireless access point that creates the wireless network to which the electronic device will connect. The settings may alternatively be gathered from a user via an input device made available on the computing device, especially when the computing device is not already a member of the wireless access point. The connection settings may be gathered from a variety of other locations, but must be gathered so as to comprise the security settings necessary for devices to connect to the wireless network. It is foreseen, therefore, that among the connection settings gathered, information such as security protocol and passphrase are likely to be gathered. Once gathered, the connection settings are stored in a location suitable to persist them until communication is established with the electronic device.

Step S430 entails triggering the electronic device which is not a member of the wireless network to enter a configuration mode. While the electronic device may be triggered in a variety of fashions, some suitable fashions foreseen in the present invention include a physical button on the electronic device, a virtual button on a touch-screen display on the electronic device, a logical check of SSIDs detected within range of the electronic device, or a timing rule for the electronic device. Once triggered, the electronic device enters configuration mode, which indicates that the electronic device is capable of communicating with a computing device to receive configuration by that computing device.

In one embodiment of the invention, entering configuration mode may cause the electronic device to send out ad hoc network requests to all computing devices within range. The configuration mode may also cause the electronic device to establish itself as a wireless access point and transmit its presence with a pre-specified SSID to all computing devices within range. Such an SSID would be understood by both the electronic device and the computing device to indicate that the electronic device is attempting to receive wireless network configuration settings from a computing device already connected to the wireless network. The configuration mode may also cause the electronic device to communicate configuration requests to devices to which it is already connected via wireless and wired connections.

When step S430 terminates, control passes to step S440, in which the computing device is connected to the electronic device. In one embodiment of the invention, the computing device receives the ad hoc network request transmitted by the electronic device in step S430 and accepts the request, thereby establishing a wireless network connection to the electronic device. In another embodiment of the invention, the computing device receives the SSID transmission from the electronic device acting as a wireless access point as performed in step S430. The computing device requests to connect to the electronic device's wireless network, which the electronic device accepts, thereby establishing a wireless network connection between the two devices. In another embodiment, the electronic device and computing device are already connected, and the computing device receives the configuration request via that existing connection. In this embodiment, the electronic device and computing device may not create an additional network link. It is foreseen that other embodiments of the invention comprise creating other forms of wired and wireless network connections between the computing device and the electronic device in step S440.

When both step S420 and step S440 terminate, control passes to step S450, during which the electronic device is configured with connection settings for the wireless network. In one embodiment of the invention, a process running on the computing device retrieves the connection information stored during step S420 and communicates that information to a process running on the electronic device. The process on the electronic device then stores the connection information on the electronic device by communicating with the electronic device's operating system or a network utility running thereon. The electronic device is thereby properly configured to connect to the wireless network and either the computing device or the electronic device may terminate the network connection created between them as it is no longer needed.

When step S450 terminates, the electronic device is properly configured and can join the wireless network. Control passes to step S460 wherein the process ends.

In various embodiments the modules described above may be provided as either software, hardware, or some combination thereof. For example, the system may be implemented on one or more server-class computers, such as a PC having a CPU board containing one or more processors such as those manufactured by Intel Corporation of Santa Clara, Calif., Motorola Corporation of Schaumburg, Ill., and/or Advanced Micro Devices, Inc., of Sunnyvale, Calif. The processor may also include a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), programmable logic devices (PLD), or read-only memory devices (ROM). In some embodiments, the programs may be provided using external RAM and/or ROM such as optical disks, magnetic disks, as well as other commonly storage devices.

For embodiments in which the invention is provided as a software program, the program may be written in any one of a number of high level languages such as FORTRAN, PASCAL, JAVA, C, C++, C#, LISP, PERL, BASIC or any suitable programming language. Additionally, the software can be implemented as application specific integrated circuitry.

As described above, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A system for joining an electronic device to a secure wireless network, said system comprising:
a triggering module for triggering said electronic device to enter a configuration mode, said configuration mode allowing said electronic device to connect to and be configured by a computing device;
a setting module for gathering connection settings comprising security settings for said wireless network from said computing device, said computing device being a member of said wireless network;
a networking module for creating a network link between said computing device and said electronic device, the creating of said network link enabled at least in part by said triggering said electronic device to enter the configuration mode; and
a configuration module for communicating across said network link with said electronic device in order to configure said electronic device with said connection settings.

2. The system of claim 1, wherein said wireless network uses an IEEE 802.11 protocol for communication.

3. The system of claim 1, wherein said wireless network is secured using a protocol selected from the group consisting of WEP, WPA, and WPA2.

4. The system of claim 1, wherein said computing device comprises a user interface with a display screen and said electronic device is devoid of a user interface having a display screen.

5. The system of claim 1, wherein said triggering module triggers said electronic device to enter said configuration mode based on input from a user interacting with said electronic device.

6. The system of claim 1, wherein said electronic device sends requests for ad hoc networks to all computing devices within transmission range when entered into said configuration mode.

7. The system of claim 1, wherein said electronic device establishes itself as a wireless access point and transmits its presence along with a pre-specified SSID indicating that said electronic device is in said configuration mode.

8. The system of claim 1, wherein said settings gathering module gathers said connection settings from the computing device on which said settings gathering module is located.

9. The system of claim 1, wherein said settings gathering module gathers said connection settings from the wireless access point that created said wireless network.

10. The system of claim 1, wherein said settings gathering module gathers said connection settings from a user via an input device on said computing device.

11. A computer-implemented method for joining an electronic device to a secure wireless network, said method comprising the following steps:
triggering said electronic device to enter a configuration mode, said configuration mode allowing said electronic device to connect to and be configured by a computing device;
gathering connection settings comprising security settings for said wireless network from said computing device, said computing device being a member of said wireless network;
connecting via a network link said computing device to said electronic device, the connecting via said network link enabled at least in part by triggering said electronic device to enter said configuration mode; and
communicating across said network link with said electronic device in order to configure said electronic device with said connection settings.

12. The method of claim 11, wherein said wireless network uses an IEEE 802.11 protocol for communication.

13. The method of claim 11, wherein said wireless network is secured using a protocol selected from the group consisting of WEP, WPA, and WPA2.

14. The method of claim 11, wherein said computing device comprises a user interface with a display screen and said electronic device is devoid of a user interface with a display screen.

15. The method of claim 12, wherein said step of triggering is based on input from a user interacting with said electronic device.

16. The method of claim 12, wherein said electronic device sends requests for ad hoc networks to all computing devices within transmission range when entered into said configuration mode.

17. The method of claim 12, wherein said electronic device establishes itself as a wireless access point and transmits its presence along with a pre-specified SSID indicating that said electronic device is in said configuration mode.

18. The method of claim 12, wherein said connection settings are gathered from a computing device that is not the wireless access point that created said wireless network.

19. The method of claim 12, wherein said connection settings are gathered from the wireless access point that created said wireless network.

20. The method of claim 12, wherein said connection settings are gathered from a user via an input device on said computing device.

21. A system for joining an electronic device to a secure wireless network, said system comprising:
a triggering module for triggering said electronic device to enter a configuration mode, said configuration mode allowing said electronic device to connect to and be configured by a computing device;
a setting module for gathering connection settings comprising security settings for said wireless network from said computing device;
a networking module for detecting the configuration mode of said electronic device; and
a configuration module for communicating across a network link with said electronic device in order to configure said electronic device with said connection settings.

22. The system of claim 21, wherein said wireless network uses an IEEE 802.11 protocol for communication.

23. The system of claim 21, wherein said wireless network is secured using a protocol selected from the group consisting of WEP, WPA, and WPA2.

24. The system of claim 21, wherein said computing device comprises a user interface with a display screen and said electronic device is devoid of a user interface having a display screen.

25. The system of claim 21, wherein said triggering module triggers said electronic device to enter said configuration mode based on input from a user interacting with said electronic device.

26. The system of claim 21, wherein said electronic device sends requests for ad hoc networks to all computing devices within transmission range when entered into said configuration mode.

27. The system of claim 21, wherein said electronic device establishes itself as a wireless access point and transmits its presence along with a pre-specified SSID indicating that said electronic device is in said configuration mode.

28. The system of claim 21, wherein said settings gathering module gathers said connection settings from the computing device on which said settings gathering module is located.

29. The system of claim 21, wherein said computing device is a member of said wireless network and said settings gathering module gathers said connection settings from the wireless access point that created said wireless network.

30. The system of claim 21, wherein said settings gathering module gathers said connection settings from a user via an input device on said computing device.

31. The system of claim 21, wherein said networking module, upon detection of said electronic device in said configuration mode, further creates a network link between said computing device and said electronic device, the creating of said network link enabled at least in part by said triggering said electronic device to enter the configuration mode.
